(19) United States
(12) Patent Application Publication
(10) Pub. No.: US 2006/0144797 A1
(43) Pub. Date: Jul. 6, 2006

(54) Processes for the treatment of a waste material having a high ph and/or alkalinity

(76) Inventors: David McConchie, Goonellabah (AU); Malcolm William Clark, Lismore (AU); Fiona Gaye Davies-McConchie, Goonellabah (AU); Thomas Hans Ryffel, Goolmangar (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/520,241

(22) PCT Filed: Jul. 4, 2003
(86) PCT No.: PCT/AU03/00865

§ 371 Date: Oct. 26, 2005

(30) Foreign Application Priority Data
Jul. 4, 2002 (AU) PS 3381

(51) Int. Cl. C02F 1/52

(52) U.S. Cl. 210/724

(57) ABSTRACT

A process for the treatment of a waste material containing species having a high alkalinity and/or pH is disclosed. The process comprises the steps of contacting the waste material with a first treatment material such as sea water concentrated by evaporation. The amount of the first treatment material is sufficient to cause at least some of the alkaline species to be inactivated, thereby resulting in a treated waste material. The process may also include a step of separating the treated waste material into solid and liquid phases and then contacting the liquid phase with a sufficient amount of a second treatment material having a low pH, so as to cause at least one of the pH and alkalinity of the liquid phase to be reduced to an environmentally acceptable level.

### TECHNICAL FIELD

The present invention relates to the treatment of materials having a high or a low pH and/or alkalinity. More particularly, the invention relates to processes for the treatment of residues, by-products and waste materials arising from bauxite refineries.

### BACKGROUND OF THE INVENTION

The production of alumina by the Bayer process results in the creation of process residues that are commonly known as ‘red mud’. Typically, for each ton of alumina that is produced, between one and two tons of ‘red mud’ are produced (on a dry basis). This red mud must be either stored indefinitely or disposed of in an environmentally friendly manner.

The raw red mud is highly caustic having a pH that is usually greater than 13.0 and often about 13.5. Consequently, there are substantial problems associated with its storage, including:
1. Highly caustic water and sediment presents a serious threat to any wildlife or humans that come into contact with it, because it can cause severe caustic burns or death.
2. The cost of containment is high and the land used for storage is not available for other purposes.
3. The escape of caustic leachate from storage areas into local groundwater systems is difficult to prevent and may persist long after the deposition of red mud in the storage area has ceased.
4. The cost of managing and maintaining caustic red mud storage facilities is high.
5, The costs associated with public liability insurance and environmental protection and remediation bonds are high and are likely to increase further in future.

These costs and liabilities can best be reduced by not having to store the red mud. Because of the large volumes of red mud that are produced, it is thus desirable that it be used in some application. However, both transport and reuse will usually require at least partial neutralisation of the caustic. Natural weathering processes eventually neutralise stored red mud, but adequate neutralisation will take many decades to achieve and, in the interim, all the problems listed above will be applicable. Thus, it is desirable to neutralise the red mud in such a way that it is no longer highly caustic.

Several alternative procedures for achieving this objective have been proposed in the past, including the addition of acids (usually waste sulphuric acid or acidic water produced during the scrubbing of acid forming gases produced, for instance, during coal combustion) to reduce the pH below 10.5 for safer storage, or alternatively, the addition of large volumes of seawater (which may be concentrated by evaporation), or the addition of gypsum or chlorides of calcium and magnesium (or other soluble calcium and magnesium salts) to convert the basicity (mainly sodium hydroxide) and other soluble alkalinity (mainly sodium carbonate) into low solubility compounds. Other alternatives included use of the caustic red mud to neutralise acid forming gases produced during coal combustion, or the treatment of the wet red mud with large volumes of carbon dioxide. There are also other options, but none are in widespread use.

All of these strategies can be used with varying degrees of efficiency and at varying costs to neutralise caustic red mud and thereby wholly or partly to resolve some or all of the problems listed in 1 to 5 above.

Thus, for any potential high volume option to be able to solve all the problems listed above, it should make use of the ability of the red mud to neutralise acid and to tap and bind a wide range of trace metals and other substances. This requirement constrains the selection of neutralisation options. Some of the disadvantages of the existing processes are as follows.

Neutralisation using acids is reasonably cheap if sufficiently large quantities of waste acid are available and need to be disposed of. This particularly applies where contaminated waste acids are produced during scrubbing of acid forming gasses (primarily sulphur dioxide) arising from coal combustion. However, waste acids are rarely available in sufficient quantities to neutralise all the red mud generated at a bauxite refinery and the resulting neutralised red mud has almost no value for use in treating acidic and/or metal contaminated waters or sulphidic waste rock, tailings or soils. Thus, unless some other use for this material is identified, red mud neutralised in this way must be stored indefinitely and the storage area must ultimately be rehabilitated.

Neutralisation using large volumes of sea water can be very effective if the bauxite refinery is near the coast. The use of sea water contributes to the conservation of fresh water, and the resulting seawater-neutralised red mud is suitable for use in treating acidic and/or metal contaminated waters or sulphidic waste rock, tailings or soils, etc. However, large amounts of seawater are required (typically between 12 and 18 times the volume of raw red mud to be neutralised) if the discharge water is to meet normal environmental standards. In addition, large ponds are required to allow the solids to settle before the calcium and magnesium depleted seawater used in the neutralisation process can be returned to the sea. These limitations as well as certain other water quality management problems add substantially to the cost of the neutralisation process through the large volumes of fluids that need to be moved and the large pond sizes required.

The addition of certain calcium and magnesium salts (usually the chloride salts) can be applied at refineries that are not close to the coast. This results in the production of a neutralised red mud that is suitable for use in treating acidic and/or metal contaminated waters or sulphidic waste rock, tailings or soils, etc. Smaller settling ponds are required, but the waste brines need to be disposed of (usually by evaporation). Large amounts of soluble calcium and magnesium salts are required. Both the cost of the soluble calcium and magnesium salts and the cost of managing the saline brines can be high.

The technique of using evaporatively concentrated sea water to neutralise the red mud combines the low cost of seawater with the reduced fluid volumes required for the addition of calcium and magnesium salts. This technique can also make use of low cost calcium- and magnesium-rich saline groundwaters as well as salt take brines where they are available. The requirement for costly additional soluble calcium and magnesium salts is minimised and the treatment produces a neutralised material that is suitable for use in treating acidic and/or metal contaminated waters, sulphidic waste rock, tailings or soils, etc. However, the construction of one or more large evaporation basins may be required and management costs for the calcium and magnesium-depleted waste brines may be high.

The technique of using the caustic red mud to neutralise acid forming gases produced during coal combustion is used at some refineries, but its primary purpose is to clean the gas emissions and not to neutralise the red mud. Neutralising the red mud is an incidental benefit, but it will only ever apply to a proportion of the red mud produced at each refinery. Furthermore, the resulting neutralised red mud has almost no value for reuse in treating acidic and/or metal contaminated waters or sulphidic waste rock, tailings or soils and unless some other reuse for this material is identified, it must be stored indefinitely and the storage area must ultimately be rehabilitated.

Neutralisation using gypsum or carbon dioxide or similar strategies can produce a red mud that is safe to store. However, the procedures can be costly and the resulting neutralised red mud has low value for reuse in treating acidic and/or metal contaminated waters or sulphidic waste rook, tailings or soils and unless some other reuse for this material is identified, it must be stored indefinitely and the storage area must ultimately be rehabilitated.

### OBJECT OF THE INVENTION

It is an object of the present invention to overcome or substantially ameliorate at least one of the above disadvantages.

### SUMMARY OF THE INVENTION

According to a first aspect of the present invention, there is provided a process for the treatment of a waste material containing a first species having a high alkalinity and/or pH, comprising the steps of:
(a) contacting the waste material with an amount of a first treatment material sufficient to cause at least some of the said first species to be inactivated, thereby resulting in a treated waste material; and
(b) thereafter contacting the treated waste material with a sufficient amount of a second treatment material having a low pH, so as to cause at least one of the pH and alkalinity of the waste material to be reduced to an environmentally acceptable level.

According to a second aspect of the present invention, there is provided a process for the treatment of a waste material containing a first species having a high alkalinity and/or pH, comprising the steps of:
(a) contacting the waste material with an amount of a first treatment material sufficient to cause at least some of the said first species to be inactivated, thereby resulting in a treated waste material; and
(b) thereafter contacting a liquid phase separated from the waste material with a sufficient amount of a second treatment material having a low pH, so as to cause at least one of the pH and alkalinity of the liquid phase to be reduced to an environmentally acceptable level.

As used in this specification, the words “inactivating”, and “inactivated” shall be taken to include, but not be limited to, neutralisation or conversion of a liquid phase, a solid phase, a species, a waste material, a treated waste material or any combination or portion thereof, to at least one species having a lower pH and/or alkalinity, and/or conversion to one or more other species having a lower pH and/or alkalinity; and/or the precipitation of one or more substantially insoluble species.

The waste material may be red mud or a liquid or supernatant liquid derived or separated from red mud.

According to a third aspect of the present invention, there is provided a process for the treatment of red mud, comprising the steps of:
(a) contacting the red mud with a first treatment material comprising a water soluble salt of an alkaline earth metal, so as to reduce at least one of the pH and alkalinity of the red mud; and
(b) contacting the red mud with a second treatment material having a pH lower than 7, so as to reduce at least one of the pH and alkalinity of the red mud to an environmentally acceptable level.

In step (b) of the process according to this aspect of the invention, the pH may be reduced to less than about 9.5, preferably to less than about 9.0.

In step (b) of the process according to this aspect of the invention, the total alkalinity, expressed as calcium carbonate equivalent alkalinity, may preferably be reduced to less than 200 mg/L.

According to a fourth aspect of the present invention, there is provided a process for the treatment of red mud, comprising the steps of:
(a) contacting the red mud with a first treatment material comprising a solution containing a water soluble salt of an alkaline earth metal, so as to reduce at least one of the pH and alkalinity of the red mud and to form a resulting solution;
(b) separating the resulting solution from the red mud, and
(c) contacting the resulting solution with a second treatment material having a pH lower than 7, so as to reduce the pH of the solution to an environmentally acceptable level.

In step (c) of the process according to this aspect of the invention, the pH may be reduced to less than about 9.5, preferably to less than about 9.0.

In step (c) of the process according to this aspect of the invention, the total alkalinity of the said solution may preferably be reduced to less than 200 mg/L, expressed as calcium carbonate equivalent.

According to a fifth aspect of the present invention, there is provided a process for the treatment of a liquid component of red mud, the liquid component containing a first species having a high pH, comprising the steps of:
(a) separating the said liquid component from the red mud;
(b) contacting the said liquid component with an amount of a first treatment material sufficient to cause at least a portion of the said first species to be inactivated and a portion of the inactivated first species to be precipitated, thereby resulting in a treated liquid component; and
(c) separating said precipitated inactivated first species from the treated liquid component thereby resulting in a separated precipitate and a treated and separated liquid component; and
(d) contacting the treated and separated liquid component with a second treatment material having a pH lower than 7, so as to reduce at least one of the pH and alkalinity of the solution to an environmentally acceptable level,

In step (d) of the process according to this aspect of the invention, the pH may be reduced to less than about 9.5, preferably to less than about 9.0.

In step (d) of the process according to this aspect of the invention, the total alkalinity of the said solution may preferably be reduced to less than 200 mg/L, expressed as calcium carbonate equivalent.

According to a sixth aspect of the present invention, there is provided a process for the treatment of a liquid component of red mud, the liquid component containing a first species having a high pH, comprising the steps of:
(a) separating the said liquid component from the red mud;
(b) contacting the said liquid component with an amount of a first treatment material comprising a water soluble salt of an alkaline earth metal, sufficient to cause the pH of the said liquid component to be reduced and a precipitate to be formed, thereby resulting in a treated liquid component; and
(c) separating said precipitate from said treated liquid component thereby resulting in a separated precipitate and a treated and separated liquid component; and
(d) contacting the treated and separated liquid component with a second treatment material having a pH lower than 7, so as to reduce at least one of the pH and alkalinity of the solution to an environmentally acceptable level.

In step (d) of the process according to this aspect of the invention, the pH may be reduced to less than about 9.5, preferably to less than about 9.0.

In step (d) of the process according to this aspect of the invention, the total is alkalinity of the said solution may preferably be reduced to less than 200 mg/L, expressed as calcium carbonate equivalent.

The alkaline earth metal is typically calcium or magnesium or a mixture of the two, or more preferably, magnesium.

In Step (a) of the processes according to the first, second, third and fourth aspects of the invention, and in step (b) of the processes according to the fifth and sixth aspects of the invention, the pH of the waste material, red mud or liquid component, as the case may be, may be reduced to about 8.5-10, alternatively to about 8.5-9.5, alternatively to about 9-10, alternatively to about 9.5-10, preferably from about 9-9.5.

In Step (b) of the process according to the first, second and third aspects of the invention, in step (c) of the process according to the third aspect of the invention, and in step (d) of the processes according to the fifth and sixth aspects of the invention, the pH of the treated waste material, liquid phase, red mud, resulting solution or treated and separated liquid component, as the case may be, may be reduced to about 5.5-9.0, alternatively to about 6-8, alternatively to about 6.5-8, alternatively to about 6.0-8.5, alternatively to about 6.5 8.5, alternatively to about 9-9.5, preferably to about 7.0-8.5, ideally to less than about 9.0.

In Step (a) of the processes according to the first, second, third and fourth aspects of the invention, and in step (b) of the processes according to the fifth and sixth aspects of the invention, the total alkalinity, expressed as calcium carbonate alkalinity, of the waste material, red mud or liquid component, as the case may be, may be reduced to about 200 mg/L-1000 mg/L, alternatively to about 200 mg/L-900 mg/L, alternatively to about 200 mg/L-800 mg/L, alternatively to about 200 mg/L-700 mg/L, alternatively to about 200 mg/L-600 mg/L, alternatively to about 200 mg/L-500 mg/L, alternatively to about 200 mg/L-400 mg/L, alternatively to about 200 mg/L-300 mg/L, alternatively to about 300 mg/L-1000 mg/L, alternatively to about 400 mg/L-1000 mg/L, alternatively to about 500 mg/L-1000 mg/L, alternatively to about 600 mg/L-1000 mg/L, alternatively to about 700 mg/L-1000 mg/L, alternatively to about 800 mg/L-1000 mg/L, alternatively to about 900 mg/L-1000 mg/L, preferably less than 300 mg/L

In Step (b) of the process according to the first, second and third aspects of the invention, in step (c) of the process according to de third aspect of the invention, and in step (d) of the processes according to the fifth and sixth aspects of the invention, the total alkalinity, expressed as calcium carbonate alkalinity, of the treated waste material, liquid phase, red mud, resulting solution or treated and separated liquid component, as the case may be, may be reduced to about 200 mg/L-500 mg/L, alternatively to about 200 mg/L-400 mg/L, alternatively to about 200 mg/L-300 mg/L, alternatively to about 200 mg/L-250 mg/L, preferably less than 200 mg/L.

The first treatment material may be selected from sea water, evaporatively concentrated sea water, a water soluble salt of calcium, a water soluble salt of magnesium, calcium chloride, magnesium chloride, magnesium sulphate, a brine containing a water soluble salt of calcium, a brine containing a water soluble salt of magnesium, or any combination thereof. The brines containing the water soluble salts (most importantly the calcium and magnesium salts) can be natural brines or they can have an anthropogenic origin (e.g. the waste water streams from a reverse osmosis desalination plant). The first treatment material may thus be a calcium and/or magnesium rich waste water from a reverse osmosis desalination plant. Calcium and/or magnesium rich for purposes of serving as a first treatment material may require calcium and magnesium concentrations similar to those encountered in concentrated sea water as aforementioned.

The pH of the first treatment material is not very important but it may typically be between about 6.0 and about 10.0. The concentration of the first treatment material is also not critical but the concentrations are preferably greater than the base amounts for calcium and magnesium; the base amount for calcium being about 150 mg/L and the base amount for magnesium being about 250 mg/L. However, it is desirable to have amounts of about 200 to 300 mg/L for calcium and about 300 to about 750 mg/L for magnesium present in the first treatment material. For the treatment to work efficiently, concentrations in the higher regions of and even exceeding the upper limits of the aforementioned ranges, are preferred, the concentrations to be used depending on the solubilities of various compounds that may be formed in the solution and the temperature thereof.

The second treatment material may be selected from waste acid, acidic water obtained from a flue gas scrubber or from gases obtained from the roasting or combustion of pyritic material, coal or oil, any other acid, or any combination thereof.

The second treatment material may be a solution containing an acid or waste acid and therefore its pH should preferably be below about 6.0. It will be appreciated that, the lower the pH (and hence the higher the concentration of hydrogen ions or acid) in the second treatment material, the better because the lower the pH the less of the second treatment material will be required. Ideally, the pH of the second treatment material should be less than about 2.0 and preferably less than 1.0. (of course pH is a function of the concentration of hydrogen ions and hence a separate requirement for concentration is not needed

In step (a) of the process according to the second aspect of the invention, the liquid phase may have a pH of 9.0 to 9.5 after contacting with the first treatment material. Alternatively or additionally, it may have an alkalinity of 300 mg/L or less. To optimise treatment of the red mud, the solid and liquid phases are preferably thoroughly mixed and kept in contact for at least 5 minutes. After treatment in step (a) of the process according to this aspect of the invention, the solid and liquid phases may be separated by settling the solids phase, whereafter the liquid phase may be drawn off.

In step (b) of the process according to the second aspect of the invention, at least a portion of the second treatment material may be added to the liquid phase until the pH thereof is less than 9.0 and the alkalinity is less than 200 mg/L. The liquid phase may be discarded to the sea. Alternatively, the liquid phase or a portion thereof may be transferred to an evaporating pond for salt recovery.

In a further step of the process according to this aspect of the invention, the solid phase may be dried wholly or partly. Alternatively, it may be retained as a slurry for reuse or storage as required. The solid material may be further treated or modified by washing with fresh water or by the addition of chemical additives as required for any particular intended reuse.

The solids phase obtained from the separation of the red mud from the first treatment material may be fully neutralized, in a subsequent step, to give a reaction pH of between 7.0 and 8.5, or to a pH well below the strictest standards imposed for safe transport and reuse (i.e. the reaction pH should be less than 11.5 and should preferably be less than 10.5; according to the Basel Convention). Conveniently, it is neutralised to a reaction pH of less than 10.5. Environmental standards normally impose no limits on alkalinity. TCLP (Toxicity Characteristic Leaching Procedure) values for the solid material are normally sufficiently low that it can be classified as an environmentally safe inert solid. This material can be transported as a slurry or as a dried or partly dried solid for reuse, whichever form is most convenient.

The solids material may comprise the following minerals (in decreasing order of abundance) hematite [Fe₂O₃], boehmite [γ-AlOOH], gibbsite [Al(OH)₃], sodalite [Na₄Al₃Si₃O₁₂Cl], quartz [SiO₂], and cancrinite [(Na,Ca,K)₈(Al,Si)₁₂O₂₄(SO₄,CO₃).3H₂O] and other minerals (in alphabetical order) usually including but not limited to aragonite [CaCO₃], brucite [Mg(OH)₂], calcite [CaCO₃], diaspore [β-Al₂O₃.H₂O], ferrihydrite [Fe₅O₇(OH).4H₂O], gypsum [CaSO₄.2H₂O], hydrocalumite [Ca₂Al(OH)₇.3H₂O], hydrotalcite [Mg₆Al₂CO₃(OH)₁₆.4H₂O], titanium oxides, lepidocrocite [γ-FeOOH], maghemite [γ-Fe₂O₃], p-aluminohydrocalcite [CaAl₂(CO₃)₂(OH)₄.3H₂O], and portlandite [Ca(OH)₂].

If required, the solids material may be further modified by washing with fresh water to remove soluble salts. Conveniently, the wash water may be added to the treatment water produced during or after treatment with the second treatment material. Alternatively, the wash water and optionally any additional chemical additives as required for any particular intended reuse, may be applied to the solids phase after neutralisation and before reuse.

It has been found by the inventors that when seawater or concentrated seawater, or other calcium- and magnesium-rich brines, or a mixture of soluble calcium and magnesium salts (usually the chloride salts), or any combination thereof, is added to the caustic red mud, or to the liquor that can be separated from caustic red mud, produced as a by-product of alumina production using the Bayer Process, the neutralising effect of the additives is initially large, However, the effect decreases rapidly as complete neutralisation is approached.

Complete neutralisation is defined as when the liquid that can be separated from the treated red mud or treating solution mixture has a pH less than 9.0 and a total alkalinity less than 200 mg/L (as calcium carbonate equivalent alkalinity). Such water can be safely discharged to the marine environment. Complete neutralisation using seawater alone will normally require the addition of between 12 and 18 volumes of world average seawater (412 mg calcium/L and 1,290 mg magnesium/L) for each volume of red mud waste. The exact amount of seawater required depends primarily on the proportion of solids in the original red mud and on its initial alkalinity.

It is to be understood that, throughout this document, alkalinity is intended to mean calcium carbonate equivalent alkalinity.

As an alternative to sea water, water soluble calcium and/or magnesium salts may be used in similar quantities to the quantities of calcium and magnesium salts obtained from sea water.

The inventors have found that if an untreated red mud has a pH of about 13.5 and an alkalinity of about 20,000 mg/L, the addition of about 5 volumes of world average seawater will reduce the pH to between 9.0 and 9.5 and the alkalinity to about 300 mg/L.

However, the addition of a further 8 to 12 volumes of world average seawater will be required to reduce the pH to below 9.0 and the alkalinity to less than 200 mg/L as required for water to be discharged to the marine environment. If the original alkalinity of the red mud is higher or lower than the value of about 20,000 mg/L, then the amount of seawater required for partial or complete treatment would need to be increased or decreased in proportion to the increase or decrease in the alkalinity above or below the 20,000 mg/L value. Thus, greater than 95% of the treatment can be completed using about one third of the amount of seawater required for complete treatment, thereby resulting in substantially reduced water handling and storage costs.

The liquid phase may need to be treated further before it will comply with the requirements for discharge to the marine environment. If, for example, the liquid phase has a pH of between 9.0 and 9.5 and an alkalinity of about 300 mg/L, it may be required to reduce the pH to less than 9.0 and to reduce the alkalinity to 200 mg/L or lese. Once the liquid phase is separated from the solid phase, reduction of the pH and the alkalinity of the liquid phase may be achieved by adding a small quantity of acid (waste acid or acidic water from scrubbers in gas emission stacks is ideal). The amount of acid required, however, is not nearly as great as would be required to neutralise the original red mud; for example, whereas about 400 moles of acid would be needed to neutralism 1 kL of the original red mud (having an alkalinity of approximately 20,000 mg/L) to discharge standards, only about 2 moles are required to neutralise 1 kL of the separated liquid after treatment with seawater as described above (i.e. the equivalent of 1 L of concentrated sulphuric acid could neutralise 18 kL of the liquid remaining after seawater treatment to discharge standards). It is therefore clear that adding a small amount of acid to the original red mud will have a negligible effect on neutralising the red mud whereas adding the same amount of acid to the liquid remaining after treatment of the red mud with seawater or other calcium- and magnesium-rich brines and separation of the solid phase will have a large effect on final water quality.

Partial neutralisation is achieved when seawater or evaporatively concentrated seawater, or other calcium- and magnesium-rich brines, or a mixture of soluble calcium and magnesium salts (usually the chloride salts), or any combination thereof is added to the red mud. By the addition of any one or a combination of these treatment materials, soluble hydroxides and carbonates are converted into low solubility mineral precipitates. The result is that the basicity of the red mud is reduced whilst most of the soluble alkalinity is converted into solid alkalinity. More specifically, hydroxyl ions in the red mud wastes are largely neutralised by reaction with magnesium in the seawater or evaporatively concentrated seawater, or other calcium- and magnesium-rich brines, or a mixture of soluble calcium and magnesium salts (usually the chloride salts), or any combination thereof, to form brucite, but some is also consumed in the precipitation of hydrotalcite and by the isomorphous substitution of magnesium for calcium in aragonite or calcite or other calcium minerals. Most of the boehmite and gibbsite is present in the red mud wastes before the seawater or evaporatively concentrated seawater, or other calcium- and magnesium-rich brines, or a mixture of soluble calcium and magnesium salts (usually the chloride salts), or any combination thereof is added, but crystal growth continues as the pH of the mixture decreases and aluminum becomes less soluble. Simultaneously, calcium in the seawater or evaporatively concentrated seawater, or other calcium- and magnesium-rich brines, or a mixture of soluble calcium and magnesium salts (usually the chloride salts), or any combination thereof reduces the carbonate alkalinity in the red mud wastes by forming calcite and/or aragonite and other minerals (such as whewellite, cancrinite, fluorite, portlandite, hydrocalumite, and p-aluminohydrocalcite). Some carbonate is also consumed in the precipitation of cancrinite, p-aluminohydrocalcite and hydrotalcite.

Both “base amounts” and “treating amounts” of calcium and magnesium are required. The treating amounts of magnesium and calcium take part in the reactions described above and are amounts over and above the base amounts, which represent the concentrations below which minimal treatment will occur or treatment will take place very slowly. The base amounts also represent the minimum amounts that are likely to be present in solution once a major portion, say at least 50%, of the neutralisation has been completed; i.e. not all the calcium and magnesium takes part in the reaction. The base amount for calcium is about 150 mg/L (about 4 millimoles/L) and the base amount for magnesium is about 250, mg/L (about 10 millimoles/L) and unless the calcium and magnesium concentrations in the seawater or evaporatively concentrated seawater or other calcium- and magnesium-rich brines or a mixture of soluble calcium and magnesium salts (usually the chloride salts) or any combination thereof are in excess of these amounts, neutralisation reactions will proceed extremely slowly if at all.

Furthermore, it has been found that for efficient neutralisation, the amount of calcium and magnesium present in the first treatment material should be not less than about 300 mg/L for calcium (about 7.5 millimoles/L) and about 750 mg/L for magnesium (about 30 millimoles/L). These amounts are respectively equivalent to the base amount of calcium plus about 150 mg/L calcium and the base amount of magnesium plus about 500 mg/L magnesium. Reactions using lesser amounts of calcium and/or magnesium will be slow and will involve undesirably large volumes of treating fluids, whilst greater concentrations will work much more efficiently and will involve greatly reduced treating fluid volumes.

For red mud with an initial alkalinity of about 20,000 mg/L, treating amounts of about 4,200 mg of magnesium and about 1,000 mg of calcium will be required per litre of the red mud, whilst more would be required for a red mud having a higher initial alkalinity and less would be required for a red mud having a lower initial alkalinity.

The ratio of the treating amount of magnesium to the treating amount of calcium should be at least about 2, conveniently from about 6 to about 25, preferably from about 12 to about 16, more preferably from about 13 to about 15, ideally about 14 moles of magnesium per mole of calcium, The aforementioned variations in the molar ratios are acceptable provided that the minimum base amounts and the minimum treating amounts of at least one, and preferably both calcium and magnesium are present in the first treatment material.

Seawater may be used in the red mud neutralisation process according to invention primarily because it can be a cheap and abundant source of calcium and magnesium ions. However, it has been found by the inventors that evaporatively concentrated seawater works more effectively because there are more calcium and magnesium ions present in it (as the treating amounts) over and above the base amounts. This means, for instance, that seawater with twice the normal concentration of calcium and magnesium is much more effective as a neutraliser than twice the volume of normal seawater.

Furthermore, because the magnesium ions are more important than the calcium in the neutralisation process, it is possible to use seawater or other brines that are concentrated beyond the point at which calcium carbonate (or even gypsum) begins to precipitate. Thus, where evaporatively concentrated seawater is available, the volumes of water required to achieve adequate neutralisation can be reduced substantially compared to the volumes of normal seawater that would be needed. For example, at twice normal marine salinity, red mud with an initial alkalinity of about 20,000 mg/L could be adequately neutralised in accordance with Step (a) of all aspects of the process using a little more than 2 kL of the water per 1 kL of the red mud compared to about 5 kL of normal seawater per 1 kL of the red mud. Similarly, if seawater with one and one half times normal marine salinity is used, red mud with an initial alkalinity of about 20,000 mg/L could be adequately neutralised using about 3.5 kL of the water per 1 kL of the red mud compared to about 5 kL of normal seawater per 1 kL of the red mud.

Where seawater is not available, any other convenient source of calcium- and magnesium-rich brines may be used instead. Such brines may be obtained from natural sources such as groundwater or salt lake brines or they may be prepared artificially by adding calcium and magnesium salts to brines (including seawater) or waters that contain insufficient calcium and/or magnesium, or they may be calcium- and magnesium-rich waste water brines such as in the waste stream from reverse osmosis desalination plants. When calcium and magnesium salts are added, it is desirable to use the chloride salts (because these salts are reasonably cheap and readily available). Magnesium sulphate salts may also be used, but the solubility of calcium sulphate is too low to work efficiently. Oxides, hydroxides and carbonates of calcium and magnesium are not suitable because they will not help to reduce the soluble alkalinity.

Where evaporatively concentrated seawater or calcium- and magnesium-rich brines, or a mixture of soluble calcium and magnesium salts, or any combination thereof, is used instead of seawater, red mud neutralisation and discharge water conditioning may follow the same steps as described above for neutralisation using seawater. However, when is using treating solutions that do not include seawater, or evaporatively concentrated seawater, or compositionally similar brines, a reduction in the buffering capacity that is normally supplied by the seawater may mean that pH readings are unstable and may change rapidly. In these circumstances, monitoring the progress of neutralisation should be based on changes in alkalinity and getting the alkalinity down to 300 mg/L or less for the preparation of treated red mud, and down to 200 mg/L or less for the preparation of waste water for discharge.

The process according to this aspect of the invention may also be used in the neutralisation of any supernatant caustic liquor that may be separated from the red mud before any treatment is commenced or at any stage of partial treatment of the red mud.

The process according to this aspect of the invention offers the most cost-effective and, accordingly, the best method currently known to the inventors for neutralising caustic red mud residues from bauxite refineries in such a way that the treated red mud residues are environmentally safe to store, transport or reuse and such that the residual treatment liquid can be safely discharged to the marine environment or retained in an evaporating basin for salt recovery.

According to a seventh aspect of the present invention, there is provided a process for the treatment of a waste material containing a first species having a high alkalinity and/or pH, comprising the steps of:
(a) contacting the waste material with an amount of a first treatment material sufficient to cause at least some of the said first species to be inactivated, thereby resulting in a treated waste material;
(b) separating the solid and liquid phases in the mixture of waste material and treating material; and
(c) thereafter contacting the separated liquid phase with a sufficient amount of a second treatment material having a low pH, so as to cause the pH of the waste material to be reduced to an environmentally acceptable level.

The waste material may be red mud or a liquid or supernatant liquid derived or separated from red mud.

According to an eighth aspect of the present invention, there is provided a process for the treatment of red mud, comprising the steps of:
(a) contacting the red mud with a first treatment material comprising a water soluble salt of an alkaline earth metal, so as to reduce at least one of the pH and alkalinity of the red mud;
(b) separating the contacted red mud into a solid phase and a liquid phase; and
(c) contacting the separated liquid phase with a second treatment material having a pH lower than 7, so as to reduce the pH of the separated liquid phase to less than 9.0.

In step (c) of the process according to this aspect of the invention, the total alkalinity, expressed as calcium carbonate equivalent alkalinity, may be reduced to less than 200 mg/L.

According to a ninth aspect of the present invention, there is provided a process for the treatment of red mud, comprising the steps of:
(a) contacting the waste material with a first treatment material comprising a solution containing a water soluble salt of an alkaline earth metal, so as to reduce at least one of the pH and alkalinity of the red mud and to form a resulting solution;
(b) separating the solid and liquid phases in the mixture of waste material and treating material, and
(c) contacting the separated liquid phase with a second treatment material having a pH lower than 7, so as to reduce the pH of the solution to less than 9.0. In step (c) of the process according to this aspect of the invention, the total alkalinity of the said solution may be reduced to less than 200 mg/L, expressed as calcium carbonate equivalent.

### EXAMPLE

Step 1: To caustic red mud seawater was added until the liquid phase had a pH of 9.0 to 9.5 and an alkalinity of 300 mg/L or less. To optimise treatment, the solid and liquid fractions were thoroughly mixed and kept in contact for at least 5 mins.

Step 2: The solid and liquid fractions were separated by settling and decanting off of the liquid fraction.

Step 3: Waste acid was added to the liquid fraction until the pH was less than 9.0 and the alkalinity was less than 200 mg/L.

Step 4: The liquid phase, having met the environmental standards, was discharged to the sea

Step 5: The solid phase was retained as a slurry for reuse.

1. A process for the treatment of a waste material containing a first species having a high alkalinity and/or pH, comprising the steps of
(a) contacting the waste material with an amount of a first treatment material sufficient to cause at least some of the said first species to be inactivated, thereby resulting in a treated waste material;
(b) separating the solid and liquid phases in the mixture of waste material and treating material; and
(c) thereafter contacting the separated liquid phase with a sufficient amount of a second treatment material having a low pH, so as to cause the pH of the waste material to be reduced to an environmentally acceptable level.

2. A process of claim 1, wherein in step c alkalinity of the liquid phase is reduced to an environmentally acceptable level.

3. The process for the treatment of a waste material as claimed in claim 2, wherein, in step (a), said liquid phase is separated from the waste material either before or after it has been treated.

4. A process for the treatment of red mud, comprising the steps of
(a) contacting the red mud with a first treatment material comprising a water soluble salt of an alkaline earth metal, so as to reduce at least one of the pH and alkalinity of the red mud; and
(c) contacting the red mud with a second treatment material having a pH lower than 7, so as to reduce at least one of the pH and alkalinity of the red mud to an environmentally acceptable level.

5. The process for the treatment of red mud of claim 4, wherein, in step (c) of the process, the pH of the red mud is reduced to less than about 9.

6. The process for the treatment of red mud as claimed in claim 4, wherein, in step (c) of the process, the total alkalinity, expressed as calcium carbonate equivalent alkalinity, is reduced to less than 200 mg/L.

7. The process for the treatment of red mud of claim 4, further comprising the step of
(b) separating the resulting solution from the red mud; before step (c).

8. The process for the treatment of red mud as claimed in claim 4, wherein, in step (c), the pH is reduced to less than about 9.

9. The process for the treatment of red mud as claimed in claim 4, wherein, in step (c), the total alkalinity of the said solution is reduced to less than 200 mg/L, expressed as calcium carbonate equivalent.

10. A process for the treatment of a liquid component of red mud, the liquid component containing a first species having a high pH, comprising the steps of:
(a) separating the said liquid component from the red mud;
(b) contacting the said liquid component with an amount of a first treatment material sufficient to cause at least a portion of the said first species to be inactivated and a portion of the inactivated first species to be precipitated, thereby resulting in a treated liquid component;
(c) separating said precipitated inactivated first species from the treated liquid component thereby resulting in a separated precipitate and a treated and separated liquid component; and
(d) contacting the treated and separated liquid component with a second treatment material having a pH lower than 7, so as to reduce at least one of the pH and alkalinity of the solution to an environmentally acceptable level.

11. The process for the treatment of a liquid component of red mud as claimed in claim 10, wherein, in step (d), the pH is reduced to less than about 9.

12. The process for the treatment of a liquid component of red mud as claimed in claim 10, wherein, in step (d), the total alkalinity of the said solution is reduced to less than 200 mg/L, expressed as calcium carbonate equivalent.

13. The process for the treatment of a liquid component of red mud as claimed in claim 10, wherein,
the first treatment material comprising comprises a water soluble salt of an alkaline earth metal, sufficient to cause the pH of the said liquid component to be reduced and a precipitate to be formed.

14. (canceled)

15. (canceled)

16. The process for the treatment of a liquid component of red mud as claimed in claim 13 wherein the alkaline earth metal is calcium or magnesium.

17. The process as claimed in claims 1 or 4, wherein, in step (a), the pH of the waste material, or red mud is reduced to about 8.5-10.

18. The process as claimed in claim 10, wherein, in step (b), the pH of the liquid component, is reduced to about 8.5-10.

19. The process as claimed in any one of claims 1, or 4, 7, wherein the pH of the treated waste material, or red mud is reduced to about 5.5-8.

20. The process as claimed in any one of claims 1, or 4, wherein the total alkalinity, expressed as calcium carbonate alkalinity, of the waste material, or red mud is reduced to about 200 mg/L-1,000 mg/L.

21. The process as claimed in claim 20, wherein the total alkalinity, expressed as calcium carbonate alkalinity, of the treated waste material, or red mud is reduced to about 200 mg/L-500 mg/L.

22. The process as claimed in claims 1, 4 or 10, wherein the first treatment material is selected from the group consisting of sea water, evaporatively concentrated sea water, a water soluble salt of calcium, a water soluble salt of magnesium, calcium chloride, magnesium chloride, a brine containing a water soluble salt of calcium, a brine containing a water soluble salt of magnesium, and any combination thereof.

23. The process as claimed in claims 1, 4 or 10, wherein the pH of the first treatment material is between about 6.0 and about 10.

24. The process as claimed in claims 1, 4 or 10, wherein the concentration of calcium in the first treatment material is greater than about 150 mg/L and the concentration of magnesium is greater than about 250 mg/L.

25. The process as claimed in claim 24, wherein the concentration of calcium in the first treatment material is from about 200 to about 300 mg/L and the concentration of magnesium is from about 300 to about 750 mg/L.

26. The process as claimed in claims 1, 4 or 10, wherein the second treatment material is selected from the group consisting of waste acid, acidic water obtained from a flue gas scrubber, any other acid, and gases obtained from the roasting or combustion of pyritic material, coal, oil, and any combination thereof.

27. The process as claimed in claim 26, wherein the pH of the second treatment material is less than about 2.

28. The process as claimed in claim 2, wherein, in step (a), the liquid phase has a pH of 9.0 to 9.5 after contacting with the first treatment material.

29. The process as claimed in claim 2, wherein, in step (a), the liquid phase has an alkalinity of 300 mg/L or less.

30. The process as claimed in claims 1, 4 or 10, wherein the solid and liquid phases are thoroughly mixed and kept in contact for at least 5 minutes.

31. The process as claimed in claim 13, wherein, after treatment in step (a), the solid and liquid phases are separated by settling the solids phase, whereafter the liquid phase is drawn off.

32. The process as claimed in claim 31, wherein, in step (d), at least a portion of the second treatment material is added to the liquid phase until the pH thereof is less than 9.0 and the alkalinity is less than 200 mg/L.

33. The process as claimed in claim 32 further comprising drying the solids phase wholly or partly.

34. The process as claimed in claim 32, wherein, the solid phase is retained as a slurry for reuse or storage as required.

35. The process as claimed in claim 32 further comprising fully neutralizing the solids phase to a pH below 11.5.

36. The process as claimed in claim 35, wherein the solids phase is neutralised to a pH of less than 10.

37. The process as claimed in claim 32 further comprisin washing the solids phase with fresh water to remove soluble salts.

38. The process as claimed in claim 32, wherein the amount of calcium present in the first treatment material is more than about 300 mg/L or about 7.5 millimoles/L.

39. The process as claimed in claim 32, wherein the amount of magnesium present in the first treatment material is more than about 750 mg/L or about 30 millimoles/L.

40. The process as claimed in claim 32, wherein the ratio of the treating amount of magnesium to the treating amount of calcium is at least about 2.

41. The process as claimed in claim 32, wherein the first treatment material is evaporatively concentrated seawater.

42. The process as claimed in claim 41, wherein the seawater has been concentrated beyond the point at which calcium carbonate (or even gypsum) begins to precipitate.

43. The process as claimed in claim 41, wherein the seawater has been concentrated to at least one and a half times normal marine salinity,

44. The process as claimed in claim 41, wherein the first treatment material is evaporatively concentrated seawater, to which at least one of calcium salt and a magnesium salt has been added.

45. The process as claimed in claim 1, 4 or 10, wherein the first treatment material is calcium and magnesium rich waste water.

46. The process as claimed in claim 10, further comprising as a preliminary step, separating a supernatant caustic liquor from the red mud before treatment is commenced.
